(19) United States
(12) Patent Application Publication
(10) Pub. No.: US 2018/0201740 A1
(43) Pub. Date: Jul. 19, 2018

(54) Electrode Slurries Containing Halogenated Graphene Nanoplatelets, and Production and Uses Thereof

(71) Applicant: Albemarle Corporation, Baton Rouge, LA (US)

(72) Inventors: Yinzhi Zhang, Charlotte, NC (US); Zhong Tang, Charlotte, NC (US)

(21) Appl. No.: 15/855,225

(22) Filed: Dec. 27, 2017

Related U.S. Application Data
(63) Continuation-in-part of application No. PCT/US2016/040369, filed on Jun. 30, 2016.
(60) Provisional application No. 62/555,413, filed on Sep. 7, 2017.

(51) Int. Cl. C08J 3/205; C09D 5/24; C09D 7/40; C09D 127/16; C01B 32/22; C01B 32/19; H01M 4/62; H01M 10/0525; H01M 4/134

(52) U.S. Cl. CPC C08J 3/2053; C09D 5/24; C09D 7/70; C09D 127/16; C01B 32/22; C08K 3/042; H01M 4/623; H01M 4/625; H01M 10/0525; H01M 4/134; C01B 32/19

(57) ABSTRACT

This invention provides process for forming a binder slurry, which process comprises:
A) mixing halogenated graphene nanoplatelets and one or more polar solvents to form a nanoplatelet slurry, and combining the nanoplatelet slurry and one or more binders to form a binder slurry; or
B) combining i) a nanoplatelet slurry comprising halogenated graphene nanoplatelets in a polar solvent with ii) one or more binders to form a binder slurry.
   The halogenated graphene nanoplatelets comprise graphene layers and are characterized by having, except for the carbon atoms forming the perimeters of the graphene layers of the nanoplatelets, (a) graphene layers that are free from any element or component other than sp² carbon, and (b) substantially defect-free graphene layers, wherein the total content of halogen in the nanoplatelets is about 5 wt % or less calculated as bromine and based on the total weight of the nanoplatelets.

### TECHNICAL FIELD

This application claims priority of from U.S. Application No. 62/555,413, filed Sep. 7, 2017, and to International Application No. PCT/US2016/040369, filed Jun. 30, 2016, the disclosures of which are incorporated herein by reference

### TECHNICAL FIELD

This invention relates to electrode slurries formed with halogenated graphene nanoplatelets, and to applications for electrode slurries containing halogenated graphene nanoplatelets.

### BACKGROUND

Graphene nanoplatelets are nanoparticles consisting of layers of graphene that have a platelet shape. Graphene nanoplatelets are believed to be a desirable alternative to carbon nanotubes for use in similar applications.

For lithium ion batteries, in current electrode production processes, the active material and conductive aid are typically added in dry powdered form into a binder-containing solution. Graphene nanoplatelets, including chemically modified graphene nanoplatelets, are desired components for electrodes. Due to their small size, graphene nanoplatelets do not disperse well in solvents, creating challenges in their handling and in application to electrodes.

Improved methods for application of active materials and conductive aids during electrode production processes are desired. Also desired are improved methods for application of graphene nanoplatelets during electrode production processes.

### SUMMARY OF THE INVENTION

This invention provides binder slurries in polar solvents containing halogenated graphene nanoplatelets and a binder. In these binder slurries, the halogenated graphene nanoplatelets are well dispersed. For example, a binder slurry containing brominated graphene nanoplatelets in N-methyl-2-pyrrolidinone with 1.0 wt % of a binder, PVDF, is stable for more than 2 months.

This invention also provides electrode slurries in polar solvents containing halogenated graphene nanoplatelets, active material, and a binder. These electrode slurries provide several advantages. Both the halogenated graphene nanoplatelets and active material are uniformly dispersed in the electrode slurries formed in the practice of this invention than in conventionally-prepared electrode slurries. The electrode slurries of the invention have been observed to remain stable (no separation or settling) during the electrode preparation process.

Electrodes formed with electrode slurries of the invention have improved conductivity as compared to conventionally-prepared electrode slurries. This indicates that smaller amounts of conductive aids are needed to achieve a similar conductivity. The smaller amounts of conductive aids allows for a greater amount of active material in the electrode, and leads to a higher energy density of the electrode. The viscosity of an electrode slurry is usually less than the viscosity of conventionally-prepared electrode slurries, which allows the electrode slurry to contain a higher amount of solids. A higher amount of solids means that there is less solvent, which is less solvent to remove at the end of electrode preparation. The higher solid content in the electrode slurry allows for higher production rates, higher output, and/or smaller equipment. The improved conductivity of an electrode prepared with an electrode slurry of this invention permits better battery performance.

An embodiment of this invention provides processes for forming binder slurries containing halogenated graphene nanoplatelets that are characterized by having, except for the carbon atoms forming the perimeters of the graphene layers of the nanoplatelets, (a) graphene layers that are free from any element or component other than sp² carbon, and (b) substantially defect-free graphene layers; the total content of halogen in the nanoplatelets is about 5 wt % or less calculated as bromine and based on the total weight of the nanoplatelets.

Another embodiment of this invention provides processes for forming electrode slurries containing halogenated graphene nanoplatelets. Additional embodiments include electrode slurries and processes of using the electrode slurries in electrode production.

The halogenated graphene nanoplatelets are halogenated graphene nanoplatelets that have chemically-bound halogen at the perimeters of the graphene layers of the nanoplatelets. In a preferred embodiment, the halogenated graphene nanoplatelets are brominated graphene nanoplatelets that have chemically-bound bromine at the perimeters of the graphene layers of the nanoplatelets.

The halogenated graphene nanoplatelets also have high purity and little or no detectable chemically-bound oxygen impurities. Thus, the halogenated graphene nanoplatelets used in this invention qualify for the description or classification of “pristine”. In addition, the halogenated graphene nanoplatelets of this invention are virtually free from any structural defects. This can be attributed at least in part to the pronounced uniformity and structural integrity of the sp² graphene layers of the halogenated graphene nanoplatelets of this invention. Among additional advantageous features of these nanoplatelets are superior electrical conductivity and superior physical properties as compared to commercially available halogen-containing graphene nanoplatelets.

Of the halogenated graphene nanoplatelets, preferred nanoplatelets are brominated graphene nanoplatelets, i.e., nanoplatelets which have been formed using elemental bromine (Br₂) as the halogen source. Two-layered brominated graphene nanoplatelets are more preferred.

Synthesis processes for the production of these halogenated graphene nanoplatelets are described in PCT Publication WO 2017/004363. The Examples below also describe a method for making halogenated graphene platelets that are used in the practice of this invention.

These and other embodiments and features of this invention will be still further apparent from the ensuing description, drawings, and appended claims.

### BRIEF DESCRIPTION OF THE DRAWINGS

FIG. 1A is a microscope picture of a binder slurry of the invention containing 0.9 wt % brominated graphene nanoplatelets and 1 wt % PVDF in N-methyl-2-pyrrolidinone (NMP) after storage at room temperature for 2 months.

FIG. 1B is a microscope picture of a binder slurry of the invention containing 0.9 wt % brominated graphene nanoplatelets and 3 wt % PVDF in NMP after processing for 15 minutes in a homogenizer.

FIG. 2 is a graph of through-plane conductivity measurements for electrodes made with differing amounts of carbon black and/or brominated graphene nanoplatelets.

FIG. 3 is a graph of in-plane conductivity measurements for electrodes made with differing amounts of carbon black and/or brominated graphene nanoplatelets.

### FURTHER DETAILED DESCRIPTION OF THE INVENTION

In the practice of this invention, the nanoplatelet slurry comprises a polar solvent and halogenated graphene nanoplatelets. More than one polar solvent can be used. More than one type of halogenated graphene nanoplatelets can be used (e.g., brominated graphene nanoplatelets and fluorinated graphene nanoplatelets). In some embodiments, the nanoplatelet slurry consists of the polar solvent and the halogenated graphene nanoplatelets.

The binder slurries in the practice of this invention are formed from a nanoplatelet slurry and a binder, and comprise a polar solvent, halogenated graphene nanoplatelets, and a binder. More than one binder can be used. In some embodiments, the binder slurry consists of the polar solvent, the halogenated graphene nanoplatelets, and the binder. When forming a binder slurry in the practice of this invention, the binder is sometimes added in portions rather than all at once.

When combining the binder and the nanoplatelet slurry to form the binder slurries of this invention, high-speed mixing equipment is sometimes used. Such high-speed mixing equipment includes overhead mixers (stirrers) and homogenizers. Speeds for overhead mixers generally reach about 2000 rpm; for homogenizers, speeds typically range from about 500 rpm to about 35,000 rpm, depending on the particular device.

The binder slurry typically contains the binder in a concentration of about 0.1 wt % or more, preferably about 0.1 wt % to about 15 wt %, more preferably about 0.2 wt % to about 5 wt %. The halogenated graphene nanoplatelets have a concentration of about 0.1 wt % or more, preferably about 0.1 wt % to about 10 wt %, more preferably about 0.2 wt % to about 5 wt %, still more preferably about 0.2 wt % to about 1.0 wt % in the binder slurry.

Electrode slurries in the practice of this invention are formed from a binder slurry and an active material, and comprise a polar solvent, halogenated graphene nanoplatelets, a binder, and the active material. More than one type of active material can be used. In some embodiments, the electrode slurry consists of the polar solvent, the halogenated graphene nanoplatelets, the binder, and the active material.

When forming the electrode slurry, more binder is generally added. This means that the amount of binder in the binder slurry is usually less than the amount desired in an electrode slurry. Typically the amount of binder is in a binder slurry is about 15% to about 60% of the total amount of binder in the electrode slurry. For example, a binder slurry may contain about 0.5 wt % binder, and the electrode slurry formed therefrom may contain about 3.0 wt % binder.

Processes for forming a binder slurry and/or an electrode slurry can be carried out at ambient temperatures and pressures. Exclusion of oxygen and/or water is may not be necessary in these processes, depending on the polar solvent and binder chosen. The nanoplatelet slurry can be formed by any convenient means of combining (mixing) a solid and a liquid. Similarly, the binder slurry can be formed by any convenient means of combining (mixing) a solid and a slurry. While the halogenated graphene nanoplatelets are suspended in the solvent in the nanoplatelet slurry, the binder dissolves. The electrode slurry is formed by any convenient means of combining (mixing) a solid and a slurry. The active material, like the halogenated graphene nanoplatelets, is normally suspended in the electrode slurry.

Conductive aids (typically a form of carbon) can be added during formation of the binder slurry, after the binder slurry has been formed, during the formation of the electrode slurry, and/or after formation of the electrode slurry. Preferably, the conductive aid is added after formation of the binder slurry.

If desired, the binder slurry and/or electrode slurry may be formed by combining the slurry with the additive in admixture with a solvent. For example, a binder slurry can be formed by mixing the binder in a polar solvent with the nanoplatelet slurry. Similarly, the electrode slurry can be formed by mixing the active material in a polar solvent with the binder slurry.

In the processes of this invention, the polar solvent can be protic or aprotic, depending on its use and the other substances present in the electrode slurry, and is generally a polar organic solvent and/or, in some instances, water. Suitable polar solvents include polar aprotic solvents such as acetonitrile, acetone, tetrahydrofuran, sulfolane (tetramethylene sulfone), N,N-dimethylformamide, N,N-dimethylacetamide, dimethylsulfone, dimethylsulfoxide, 1,3-dimethyl-2-imidazolidinone, N-methyl-2-pyrrolidinone, or benzonitrile; and polar protic solvents such as water, methanol, ethanol, 1-propanol, 2-propanol, 1-butanol, 1-methyl-1-propanol, 2-methyl-1-propanol, tert-butanol, or ethylene glycol. Mixtures of two or more polar solvents can be used.

Suitable binders include styrene butadiene rubber and polyvinylidene fluoride (PVDF; also called polyvinylidene difluoride).

In the practice of this invention, suitable anode active materials include, but are not limited to, carbon, silicon, titanium dioxide, and lithium titanium oxide. Suitable forms of carbon for the active material in an anode include natural graphite, purified natural graphite, synthetic graphite, hard carbon, soft carbon, carbon black, powdered activated carbon, and the like.

Suitable cathode active materials in the practice of this invention include, but are not limited to, lithium salts such as lithium phosphate; lithium transition metal salts, including lithium nickel cobalt aluminum oxide, lithium nickel cobalt oxide, lithium iron phosphate, lithium manganese oxide, lithium nickel manganese spinel, lithium nickel manganese cobalt spinel, and lithium cobalt oxide.

By “pristine or nearly pristine” is meant that either there is no observable damage, or if there is any damage to the graphene layers as shown by either high resolution transmission electron microscopy (TEM) or by atomic force microscopy (AFM), such damage is negligible, i.e., it is so insignificant as to be unworthy of consideration. For example, any such damage has no observable detrimental effect on the nanoelectronic properties of the halogenated graphene nanoplatelets. Generally, any damage in the halogenated graphene nanoplatelets originates from damage present in the graphite from which the halogenated graphene nanoplatelets are made; any damage and/or impurities from the graphite starting material remains in the product halogenated graphene nanoplatelets.

The term “halogenated” in halogenated graphene nanoplatelets, as used throughout this document, refers to graphene nanoplatelets in which Br₂, F₂, ICl, IBr, IF, or any combinations thereof were used in preparing the graphene nanoplatelets.

Brominated graphene nanoplatelets are preferred halogenated graphene nanoplatelets.

The halogenated graphene nanoplatelets comprise graphene layers and are characterized by having, except for the carbon atoms forming the perimeters of the graphene layers of the nanoplatelets, (a) graphene layers that are free from any element or component other than sp² carbon, and (b) substantially defect-free graphene layers. The total content of halogen in the halogenated graphene nanoplatelets is about 5 wt % or less calculated as bromine and based on the total weight of the halogenated graphene nanoplatelets.

The phrase “free from any element or component other than sp² carbon” indicates that the impurities are usually at or below the parts per million (ppm; wt/wt) level, based on the total weight of the nanoplatelets. Typically, the halogenated graphene nanoplatelets have about 3 wt % or less oxygen, preferably about 1 wt % or less oxygen; the oxygen observed in the halogenated graphene nanoplatelets is believed to be an impurity originating in the graphite starting material.

The phrase “substantially defect-free” indicates that the graphene layers of the halogenated graphene nanoplatelets are substantially free of structural defects including holes, five-membered rings, and seven-membered rings.

In some embodiments, the halogenated graphene nanoplatelets comprise chemically-bound halogen at the perimeters of the graphene layers of the nanoplatelets. The halogen atoms that can be chemically-bound at the perimeters of the graphene layers of the halogenated graphene nanoplatelets include fluorine, chlorine, bromine, iodine, and mixtures thereof; bromine is preferred.

While the total amount of halogen present in the nanoplatelets of this invention may vary, the total content of halogen in the nanoplatelets is about 5 wt % or less, and is preferably in the range equivalent to a total bromine content (or calculated as bromine) in the range of about 0.001 wt % to about 5 wt % bromine, based on the total weight of the nanoplatelets, which is determined by the amounts and atomic weights of the particular diatomic halogen composition being used. More preferably, the total content of halogen in the nanoplatelets is in the range equivalent to a total bromine content in the range of about 0.01 wt % to about 4 wt % bromine based on the total weight of the nanoplatelets. In some embodiments, the total content of halogen in the nanoplatelets is preferably in the range equivalent to a total bromine content in the range of about 0.001 wt % to about 5 wt % bromine, more preferably about 0.01 wt % to about 4 wt % bromine, based on the total weight of the nanoplatelets.

As used throughout this document, the phrases “as bromine,” “reported as bromine,” “calculated as bromine,” and analogous phrases for the halogens refer to the amount of halogen, where the numerical value is calculated for bromine, unless otherwise noted. For example, elemental fluorine may be used, but the amount of halogen in the halogenated graphene nanoplatelets is stated as the value for bromine.

In a preferred embodiment of this invention, the halogenated, especially brominated, nanoplatelets comprise few-layered graphenes. By “few-layered graphenes” is meant that a grouping of a stacked layered graphene nanoplatelet contains up to about 10 graphene layers, preferably about 1 to about 5 graphene layers. Such few-layered graphenes typically have superior properties as compared to corresponding nanoplatelets composed of larger numbers of layers of graphene. Halogenated graphene nanoplatelets that comprise two-layered graphenes are particularly preferred, especially two-layered brominated graphene nanoplatelets.

Particularly preferred halogenated graphene nanoplatelets are brominated graphene nanoplatelets which comprise few-layered or two-layered brominated graphene nanoplatelets in which the distance between the layers is about 0.335 nm as determined by high resolution transmission electron microscopy (TEM). Brominated graphene nanoplatelets wherein said nanoplatelets comprise two-layered graphene in which the thickness of said two-layered is about 0.7 nm as determined by Atomic Force Microscopy (AFM) are also particularly preferred.

Moreover, the halogenated graphene nanoplatelets of this invention often have a lateral size as determined by Atomic Force Microscopy (AFM) in the range of about 0.1 to about 50 microns, preferably about 0.5 to about 50 microns, more preferably about 1 to about 40 microns. In some applications, a lateral size of about 1 to about 20 microns is preferred for the halogenated graphene nanoplatelets. Lateral size is the linear size of the halogenated graphene nanoplatelets in a direction perpendicular to the layer thickness.

Another advantageous feature of the halogenated graphene nanoplatelets, especially the brominated graphene nanoplatelets, is superior thermal stability. In particular, brominated graphene nanoplatelets exhibit a negligible weight loss when subjected to thermogravimetric analysis (TGA) at temperatures up to about 800° C. under an inert atmosphere. At 900° C. under an inert atmosphere, the TGA weight loss of brominated graphene nanoplatelets is typically about 4 wt % or less, usually about 3 wt % or less. Further, the TGA weight loss temperatures of brominated graphene nanoplatelets under an inert atmosphere have been observed to decrease as the amount of bromine increases. The inert atmosphere can be e.g., helium, argon, or nitrogen; nitrogen is typically used and is preferred.

Preferred halogenated graphene nanoplatelets are brominated graphene nanoplatelets comprising two-layered graphene nanoplatelets, while also having a negligible weight loss when subjected to thermogravimetric analysis (TGA) at temperatures up to about 800° C. under an anhydrous nitrogen atmosphere. Preferably, the TGA weight loss of the brominated graphene nanoplatelets is about 4 wt % or less at 900° C. under an inert atmosphere, more preferably about 3 wt % or less at 900° C. under an inert atmosphere.

At the end of their formation process, halogenated graphene nanoplatelets are often subjected to particle size reduction techniques, which include grinding, dry or wet milling, high shear mixing, and ultrasonication. Solvents for ultrasonication are typically one or more polar solvents. Suitable solvents for the ultrasonication are the polar solvents described above. When the halogenated graphene nanoplatelets are subjected to ultrasonication, the mixture, which contains halogenated graphene nanoplatelets in a polar solvent, can be used as a nanoplatelet slurry in the processes of this invention.

It is not necessary to handle the halogenated graphene nanoplatelets in a water-free and/or oxygen-free environment.

The halogenated graphene nanoplatelets are capable of use in energy storage applications from small scale (e.g., lithium ion battery electrode applications, including batteries for phones and automobiles) to bulk scale (mass energy storage, e.g., for power plants), or energy storage devices such as batteries and accumulators. More specifically, the halogenated graphene nanoplatelets may be used in electrodes in a variety of energy storage applications, including magnesium ion batteries, sodium ion batteries, lithium sulfur batteries, lithium air batteries, and lithium ion capacitor devices.

The electrode slurry can be used to form a coating on one or more surfaces of an electrode material. An electrode formed with an electrode slurry of this invention can be a component of an energy storage device. In some embodiments of this invention, energy storage devices comprising an electrode containing halogenated graphene nanoplatelets, preferably brominated graphene nanoplatelets, are provided. The electrode can be an anode or cathode. In some embodiments, the electrode may be a silicon-containing electrode, especially a silicon-containing anode. The electrode containing the halogenated graphene nanoplatelets can be present in a lithium ion battery.

The electrode slurry contains halogenated graphene nanoplatelets. The halogenated graphene nanoplatelets have a concentration of about 0.1 wt % or more, preferably about 0.1 wt % to about 10 wt %, more preferably about 0.2 wt % to about 5 wt %, still more preferably about 0.2 wt % to about 1.0 wt % in the electrode slurry. More preferably, the halogenated graphene nanoplatelets are brominated graphene nanoplatelets.

In some embodiments, the active material is in an amount such that after drying, the active material in an anode is typically about 90 wt % to about 99 wt %, more often about 97 wt % to about 98 wt %; in a cathode, the active material is usually about 90 wt % to about 97 wt %, more often about 91 wt % to about 96 wt %.

In the electrode slurry, the binder has a concentration of about 0.1 wt % or more, preferably about 0.1 wt % to about 15 wt %, more preferably about 0.2 wt % to about 8 wt %.

Preferably, the halogenated graphene nanoplatelets are brominated graphene nanoplatelets. Also preferred is an amount of about 0.1 wt % or more halogenated graphene nanoplatelets in the electrode. The electrode also comprises a binder. Typical binders include styrene butadiene rubber and polyvinylidene fluoride (PVDF; also called polyvinylidene difluoride). In preferred embodiments for these electrodes, the improvement comprises having halogenated graphene nanoplatelets, preferably brominated graphene nanoplatelets, take the place of about 10 wt % to about 100 wt % of the conductive aid(s), or the improvement comprises having halogenated graphene nanoplatelets, preferably brominated graphene nanoplatelets, take the place of about 1 wt % or more of the carbon, silicon, and/or one more silicon oxides.

The term “carbon” in connection with energy storage devices, as used throughout this document, refers to natural graphite, purified natural graphite, synthetic graphite, hard carbon, soft carbon, carbon black, or any combinations thereof.

In some energy storage devices, brominated graphene nanoplatelets may act as a current collector for the electrode, while in other energy storage devices, brominated graphene nanoplatelets may act as a conductive aid or an active material in the electrode.

The following Examples are presented for purposes of illustration, and are not intended to impose limitations on the scope of this invention.

### Sample Characterization and Performance Testing

In the experimental work described in Examples 1-3, the samples used were analyzed by the following methods in order to evaluate their physical characterization and performance.

Atomic Force Microscopy (AFM)—The AFM instrument used was a Dimension Icon® AFM made by Bruker Corporation (Billerica, Mass.) in ScanAsyst® mode with a ScanAsyst® probe. Its high-resolution camera and X-Y positioning permit fast, efficient sample navigation. The samples were dispersed in dimethylformamide (DMF) and coated on mica, and then analyzed under AFM.

High Resolution Transmission Electron Microscopy (TEM)—A JEM-2100 LaB6 TEM (JEOL USA, Peabody, Mass.) was used. Operation parameters include a 200 kV accelerating voltage for imaging and an Energy Dispersive Spectroscopy (EDS) for TEM (Oxford Instruments plc, United Kingdom) for elemental analysis. The samples were first dispersed in dimethylformamide (DMF) and coated on copper grid.

Scanning Electron Microscopy (SEM)—Electron imaging and elemental microanalysis were done in a JSM 6300FXV (JEOL USA, Peabody, Mass.) scanning electron microscope at 5 to 25 keV. The specimens were coated with a thin layer of gold or carbon prior to examination. Energy dispersive X-ray spectra were obtained using an Inca® system (Oxford Instruments plc, United Kingdom) equipped with an energy-dispersive x-ray spectrometer with a Si(Li) detector with a 5-terminal device incorporating a low noise junction field effect transistor and a charge restoration mechanism, referred to as a PentaFET Si(Li) detector (manufacturer unclear). Semiquantitative concentrations were calculated from the observed intensities. The accuracy of the values is estimated to be plus or minus twenty percent. All values are in weight percent.

Powder X-ray Diffractometer (for XRD)—The sample holder used contained a silicon zero background plate set in a mount that could be isolated with a polymethylmethacrylate (PMMA) dome sealed with an O-ring. The plate was coated with a very thin film of high vacuum grease (Apiezon®; M&I Materials Ltd., United Kingdom) to improve adhesion, and the powdered sample was quickly spread over the plate and flattened with a glass slide. The dome and O-ring were installed, and the assembly transferred to the diffractometer. The diffraction data was acquired with Cu kα radiation on a D8 Advance (Bruker Corp., Billerica, Mass.) equipped with an energy-dispersive one-dimensional detector (LynxEye XE detector; Bruker Corp., Billerica, Mass.). Repetitive scans were taken over the 100 to 140° 2Θ angular range with a 0.04° step size and a counting time of 0.5 second per step. Total time per scan was 8.7 minutes. Peak profile analysis was performed with Jade 9.0 software (Materials Data Incorporated, Livermore, Calif.).

TGA—The TGA analysis was conducted using a simultaneous DSC/TGA Analyzer with autosampler and silicon carbide furnace (model no. STA 449 F3, Netzsch-Gerätebau GmbH, Germany), which was located inside a glove box. The samples were pre-dried at 120° C. for 20 minutes, then heated up to 850° C. at 10° C./min under a flow of nitrogen or air. The remaining weight together with the temperature was recorded.

Examples 1-3 demonstrate syntheses of halogenated graphene nanoplatelets, and are reproduced from PCT Publication WO 2017/004363.

### EXAMPLE 1

Several individual 2-gram samples of natural graphite, with 35% of the particles larger than 300 microns, and 85% of the particles larger than 180 microns (Asbury Carbons, Asbury, N.J.), were contacted with 0.2 mL, 0.3 mL, 0.5 mL, 1 mL, 1.5 mL or 3 mL of liquid bromine (Br₂) for 24 hours at room temperature. After 24 hours, the color in vials from the bromine vapor was darker as the bromine vapor concentration in the vials increased. The resultant bromine-intercalated materials were analyzed by X-ray powder diffraction (XRD). Once the bromine vapor reached saturation, as shown by the presence of liquid bromine, “stage-2” bromine-intercalated graphite was formed. In the intercalation step of all the rest of the these Examples, except when specifically mentioned otherwise, saturated bromine vapor pressure was maintained during the intercalation step in order to obtain stage-2 bromine-intercalated graphite.

### EXAMPLE 2

Natural graphite (4 g), of the same particle size as used in Example 1, was contacted with 4 g of liquid bromine for 64 hours at room temperature. Excess liquid bromine was present to ensure the formation of stage-2 bromine-intercalated graphite. All of the stage-2 bromine-intercalated graphite was continuously fed during a period of 45 minutes into a drop tube reactor (5 cm diameter) that had been pre-purged with nitrogen, while the reactor was maintained at 900° C. Bromine vapor pressure was maintained in the drop reactor for 60 minutes while the temperature of the reactor was kept at 900° C. The solid material in the reactor was cooled with a nitrogen flow.

Some of the cooled solid material (3 g) was contacted with liquid bromine (4 g) for 16 hours at room temperature with excess liquid bromine present to ensure the formation of stage-2 bromine-intercalated graphite. Then all of this stage-2 bromine-intercalated graphite was continuously fed within 30 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 60 minutes while the temperature of the reactor was kept at 900° C. The solid material in the reactor was cooled with a nitrogen flow.

Some of the cooled solid material just obtained (2 g) was contacted with liquid bromine (2.5 g) for 16 hours at room temperature with excess liquid bromine present to ensure the formation of stage-2 bromine-intercalated graphite. Then all of this stage-2 bromine-intercalated graphite was continuously fed within 20 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 60 minutes while the temperature of the reactor was kept at 900° C. The solid material in the reactor was cooled with a nitrogen flow.

Part of the cooled solid material just obtained was dispersed in dimethylformamide (DMF) and subjected to ultrasonication for 6 minutes, and then analyzed with TEM and AFM. The TEM results show that the brominated graphene nanoplatelets comprised two-layered graphene, and the TEM analysis also showed that the distance (d002) between two graphene layers was about 0.335 nm, which means these graphene layers were damage-free, containing only sp² carbon in the graphene layers. The AFM analysis confirmed that the sample comprised 2-layered graphene, and also showed that the thickness of the 2-layered graphene was about 0.7 nm, which confirms that the graphene layers are damage-free and there are only sp² carbons within the graphene layers.

An EDS analysis revealed that there was 0.9 wt % bromine in the sample, as well as 97.7 wt % carbon, 1.3 wt % oxygen, and 0.1 wt % chlorine.

The sample was found to comprise two-layered brominated graphene nanoplatelets having at least a lateral size of greater than 4 microns; the sample also contained 4-layered brominated graphene nanoplatelets with the lateral size of about 9 microns.

Some of the cooled solid material from the third set of intercalation and exfoliation steps, rather than being subjected to ultrasonication, was subjected to TGA under nitrogen. The weight loss of the sample up to 800° C. was about <1%. Some of the graphite starting material was also analyzed by TGA. The weight loss from graphite was also negligible up to 800° C. in N₂. Thus it was concluded that the negligible weight loss in N₂ up to 800° C. is another characteristic feature of the brominated graphene nanoplatelets of this invention.

Some of the cooled solid material from the third set of intercalation and exfoliation steps, rather than being subjected to ultrasonication, was subjected to TGA under air. The weight loss of the sample started at about 700° C. Some of the graphite starting material was also analyzed by TGA. The weight loss from graphite was also observed to start at about 700° C. in air.

Another portion of the cooled solid material from the third set of intercalation and exfoliation steps (0.2 grams) and graphite (0.2 g) were mixed with separate 250 mL amounts of water. The cooled solid material (brominated exfoliated graphite) dispersed easily in water, while the graphite floated on top of the water. These results indicate that the brominated graphene nanoplatelets of this invention possess enhanced dispersibility in water.

### EXAMPLE 3

Natural graphite (4 g), of the same particle size as used in Example 1, was contacted with 6 g of liquid bromine for 48 hours at room temperature. Excess liquid bromine was present to ensure the formation of stage-2 bromine-intercalated graphite. All of the stage-2 bromine-intercalated graphite was continuously fed during a period of 60 minutes into a drop tube reactor (5 cm diameter) that had been pre-purged with nitrogen, while the reactor was maintained at 900° C. Bromine vapor pressure was maintained in the drop reactor for 60 minutes while the temperature of the reactor was kept at 900° C. The solid material in the reactor was cooled with a nitrogen flow.

Some of the cooled solid material (3 g) was contacted with liquid bromine (4.5 g) for 16 hours at room temperature with excess liquid bromine present to ensure the formation of stage-2 bromine-intercalated graphite. Then all of this stage-2 bromine-intercalated graphite was continuously fed during 30 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 30 minutes while the temperature of the reactor was kept at 900° C. The solid material in the reactor was cooled with a nitrogen flow.

Some of the cooled solid material just obtained (2 g) was contacted with liquid bromine (3 g) for 24 hours at room temperature with excess liquid bromine present to ensure the formation of stage-2 bromine-intercalated graphite. Then all of this stage-2 bromine-intercalated graphite was continuously fed during 20 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 60 minutes while the temperature of the reactor was kept at 900° C. The solid material in the reactor was cooled with a nitrogen flow.

Some of the cooled solid material from the third set of intercalation and exfoliation steps was analyzed by a wet titration method for bromine content, and there was 2.5 wt % of bromine in the sample.

Part of the cooled solid material from the third set of intercalation and exfoliation steps (1 g) was mixed with 50 mL of NMP, sonicated, and then filtered to obtain brominated graphene nanoplatelets. The filter cake was vacuum dried at 130° C. for 12 hours.

### EXAMPLE 4

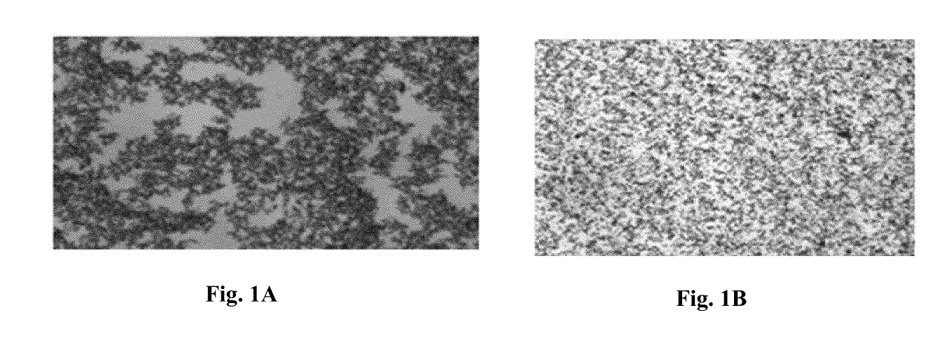

FIG. 1A is a microscope picture of a binder slurry of the invention containing 0.9 wt % brominated graphene nanoplatelets and 1 wt % PVDF in N-methyl-2-pyrrolidinone (NMP) after storage at room temperature for 2 months.

The dispersion shown in FIG. 1B, which is a binder slurry according to the invention, was prepared by adding more PVDF (to 3 wt % total) to a portion of binder slurry of FIG. 1A prior to its storage, and then processing for 15 minutes in a homogenizer (IKA® Ultra-Turrax® T8 homogenizer; 5,000 to 25,000 rpm).

### EXAMPLE 5

Conductivity measurements were made on several samples, and were performed on dried electrode coatings. Coatings were formed from electrode slurries of the invention containing 3 wt % PVDF, 1.5 wt % carbon black, brominated graphene nanoplatelets, and active material (lithium nickel cobalt manganese oxide; NMC). The brominated graphene nanoplatelets were 0.5 wt % of the slurry in one run, and 1.0 wt % of the slurry in the other run. The electrode slurry containing 0.5 wt % brominated graphene nanoplatelets had a total solid content of 64 wt %, and a viscosity of 4300 mPa.

Comparative coatings were formed from electrode slurries containing binder (3 wt % PVDF), active material (NMC), and carbon black. The amount of carbon black was different in each run: 1.0 wt %, 2.0 wt %, 3 wt %, and 4 wt %, respectively. The comparative electrode slurry containing 1.0 wt % carbon black had a total solid content of 60 wt %, and a viscosity of 11,850 mPa.

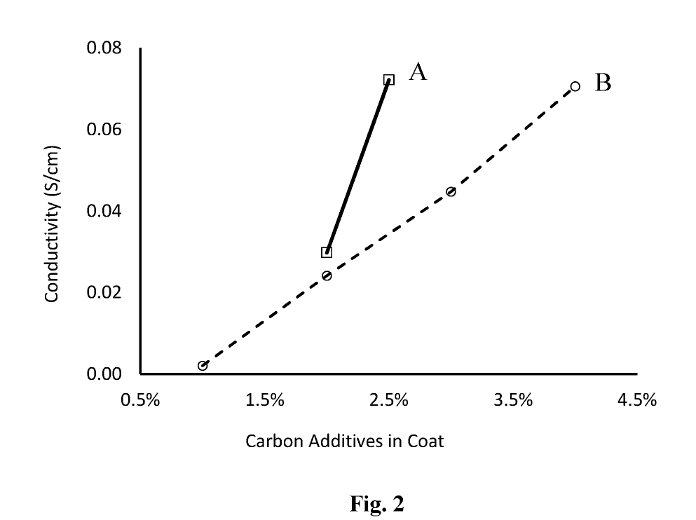

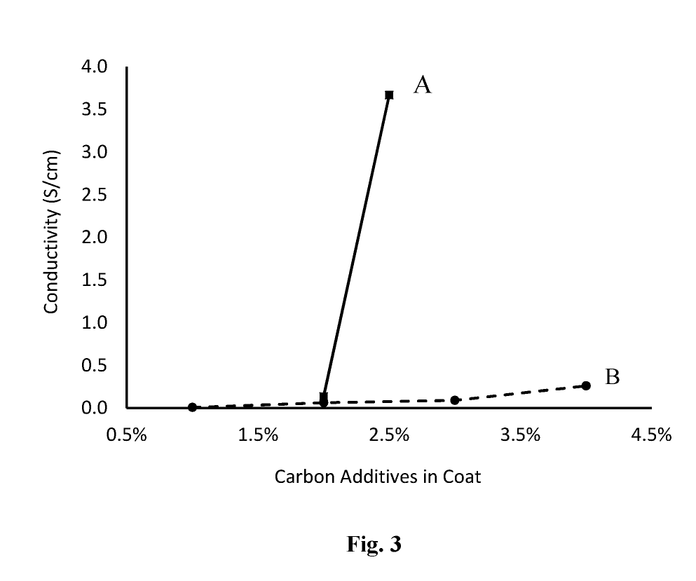

FIG. 2 is a graph of through-plane conductivity measurements and FIG. 3 is a graph of in-plane conductivity measurements. In FIGS. 2 and 3, the line labeled A is for the samples containing brominated graphene nanoplatelets; the amount on the x axis is the combined weight of the carbon black and brominated graphene nanoplatelets in the sample. Similarly, the line labeled B in FIGS. 2 and 3 is for the comparative samples, and the amount on the x axis is the amount of carbon black in the sample. These results show that the through-plane conductivity and in-plane conductivity are improved when brominated graphene nanoplatelets are present.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

That which is claimed is:

1. A process for forming a binder slurry, which process comprises:
A) mixing halogenated graphene nanoplatelets and one or more polar solvents to form a nanoplatelet slurry, and combining the nanoplatelet slurry and one or more binders to form a binder slurry; or
B) combining i) a nanoplatelet slurry comprising halogenated graphene nanoplatelets in a polar solvent with ii) one or more binders to form a binder slurry;
wherein the halogenated graphene nanoplatelets comprise graphene layers and are characterized by having, except for the carbon atoms forming the perimeters of the graphene layers of the nanoplatelets, (a) graphene layers that are free from any element or component other than sp² carbon, and (b) substantially defect-free graphene layers, wherein the total content of halogen in the nanoplatelets is about 5 wt % or less calculated as bromine and based on the total weight of the nanoplatelets.

2. A process as in claim 1 further comprising combining the binder slurry and one or more active materials to form an electrode slurry.

3. A process as in claim 1 wherein the binder is polyvinylidene fluoride.

4. A process as in claim 1 wherein the polar solvent is a polar aprotic solvent.

5. A process as in claim 1 wherein the polar solvent is N-methyl-2-pyrrolidinone.

6. A process as in claim 1 wherein the halogenated graphene nanoplatelets have chemically-bound halogen at the perimeters of the graphene layers of the nanoplatelets.

7. A process as in claim 1 wherein the halogenated graphene nanoplatelets are brominated graphene nanoplatelets that have chemically-bound bromine at the perimeters of the graphene layers of the nanoplatelets.

8. A process as in claim 1 wherein the halogenated graphene nanoplatelets are brominated graphene nanoplatelets.

9. A process as in claim 8 wherein the brominated graphene nanoplatelets have a total bromine content in the range of about 0.001 wt % to about 5 wt %, based on the total weight of the nanoplatelets.

10. A process as in claim 8 wherein the brominated graphene nanoplatelets comprise few-layered graphenes and/or wherein the brominated graphene nanoplatelets comprise two-layered graphenes.

11. A process as in claim 8 wherein the brominated graphene nanoplatelets have a distance between the layers of about 0.335 nm as determined by high resolution transmission electron microscopy

12. A process as in claim 8 wherein the brominated graphene nanoplatelets comprise two-layered graphenes have a thickness of about 0.7 nm as determined by atomic force microscopy.

13. A process as in claim 8 wherein the brominated graphene nanoplatelets exhibit a weight loss of about 4 wt % or less when subjected to thermogravimetric analysis at 900° C. under an inert atmosphere.

14. A process as in claim 8 wherein the brominated graphene nanoplatelets have a lateral size as determined by atomic force microscopy in the range of about 0.1 to about 50 microns.

15. A process as in claim 1 wherein the halogenated graphene nanoplatelets have no detectable chemically-bound oxygen impurities.

16. A binder slurry formed as in claim 1.

17. An electrode slurry formed as in claim 2.

18. A process as in claim 1 further comprising coating one or more surfaces of an electrode material with the electrode slurry.

19. A process as in claim 18 further comprising placing an electrode formed therefrom in an energy storage device.

20. A coating formed as in claim 18.

21. An energy storage device formed as in claim 19.

22. An energy storage device as in claim 21 wherein said energy storage device is a lithium ion battery.

23. An energy storage device as in claim 21 wherein said electrode is a silicon electrode.

24. An energy storage device as in claim 21 wherein said energy storage device comprises a solid state electrolyte.

25. An energy storage device as in claim 21 wherein said halogenated graphene nanoplatelets are brominated graphene nanoplatelets.
